(19) United States
(12) Patent Application Publication
(10) Pub. No.: US 2009/0297397 A1
(43) Pub. Date: Dec. 3, 2009

(54) SYSTEM AND METHOD OF PRODUCING METALS AND ALLOYS

(76) Inventors: Richard P. Anderson, Clarendon Hills, IL (US); Donn Armstrong, Lisle, IL (US); Jacobsen Lance, Minooka, IL (US)

Correspondence Address: DUNLAP CODDING, P.C. - CRISTAL, P.O. BOX 16370, OKLAHOMA CITY, OK, 73113, US

(21) Appl. No.: 12/534,501

(22) Filed: Aug. 3, 2009

Related U.S. Application Data
(63) Continuation of application No. 10/530,783, filed on Sep. 28, 2005, now abandoned.
(60) Provisional application No. 60/416,611, filed on Oct. 7, 2002.

(51) Int. Cl. B32B 15/02; B22F 9/18; C01B 35/02

(52) U.S. Cl. 420/591; 75/351; 423/298

(57) ABSTRACT

A system for producing an elemental material or an alloy thereof from a halide of the elemental material or halide mixtures comprising a reactor for introducing the vapor halide of an elemental material or halide mixtures thereof into a liquid phase of a reducing metal of an alkali metal or alkaline earth metal or mixtures thereof present in less than or equal to the amount needed to reduce the halide vapor to the elemental material or alloy resulting in an exothermic reaction between the vapor halide and the liquid reducing metal producing particulate elemental material or alloy thereof and particulate halide salt of the reducing metal, a chamber wherein the reaction products are cooled so that substantially all the particulate elemental material or alloy remains unsintered, and a separator for separating the particulate metal or alloy reaction products from the particulate salt.

### CROSS REFERENCE TO RELATED APPLICATION

The present application is a continuation of U.S. Ser. No. 10/530,783, filed Sep. 28, 2005; which claims priority to PCT/US03/27659, filed Sep. 3, 2003, in accordance with 35 U.S.C. § 119 and § 365; which claims priority to U.S. Provisional Application Ser. No. 60/416,611, filed Oct. 7, 2002, now abandoned. The specification of each of the patent applications listed above is expressly incorporated by reference herein in its entirety.

### BACKGROUND OF THE INVENTION

This invention relates to the production and separation of elemental material from the halides thereof and has particular applicability to those metals and non-metals for which a reduction of the halide to the element is exothermic. Particular interest exists for titanium, and the present invention will be described with particular reference to titanium, but is applicable to other metals and non-metals such as aluminum, arsenic, antimony, beryllium, boron, tantalum, gallium, vanadium, niobium, molybdenum, iridium, rhenium, silicon osmium, uranium, and zirconium, all of which produce significant heat upon reduction from the halide to the metal. For the purposes of this application, elemental materials include those metals and non-metals listed above, or in Table 1, and the alloys thereof.

This invention relates to the separation methods disclosed in U.S. Pat. No. 5,779,761, U.S. Pat. No. 5,958,106 and U.S. Pat. No. 6,409,797, the disclosures of which are incorporated herein by reference. The above-mentioned '761, '106 and '797 patents disclose a revolutionary method for making titanium which is satisfactory for its intended purposes and, in fact, continuously produces high grade titanium and titanium alloys by introducing halide vapor(s) of the element or alloy to be produced into the liquid phase of a reducing metal instantaneously, to initiate an exothermic reaction and to control the temperature of the reaction products by providing excess amounts of reducing metal to absorb the heat of reaction. The present invention resides the discovery that by introducing the halide vapor(s) of the element or alloy to be produced into the liquid phase of a reducing metal where the reducing metal is present in an amount equal to or less than the stoichiometric amount required to produce the elemental material (or alloy) coupled with extraneous cooling, if necessary, of the reaction products, continuous production of the elemental material (or alloy) can still be obtained, while preventing the produced material from sintering.

Previously, the Armstrong process used excess reducing metal to absorb heat produced during the exothermic reaction resulting in a startling new process. It is now believed that using an excess of halide vapor to absorb some of the heat of reaction alone, or in combination with extraneous cooling, produces many of the benefits heretofore obtained with the process of the '761, '106 and '797 patents. It is also believed that use of stoichiometric quantities of reducing metal and halide vapor in combination with extraneous cooling will produce many of the benefits heretofore obtained with the process of the '761, '106 and '797 patents.

### SUMMARY OF THE INVENTION

Accordingly, it is an object of the present invention to provide a method and system for producing metals or non-metals or alloys thereof by an exothermic reaction between vapor phase halides and a liquid reducing metal in which excess amounts of the vapor phase halides are present to absorb some of the heat of reaction and the products produced thereby.

Yet another object of the present invention is to provide an improved method and system for producing elemental materials or an alloy thereof by an exothermic reaction of a vapor halide of the elemental material or materials or halide mixtures thereof in a liquid reducing metal in which excess vapor halide in combination with a sweep gas is used to cool the products of the exothermic reaction and the products produced thereby.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings, a preferred embodiment thereof, from an inspection of which, when considered in connection with the following description, the invention, its construction and operation, and many of its advantages should be readily understood and appreciated.

FIG. 1 is a schematic representation of a system for practicing one method of the present invention;

FIG. 2 is a schematic representation of another system for practicing another embodiment of the present invention; and

FIG. 3 is a schematic representation of another system of the present invention.

### DESCRIPTION OF THE PREFERRED EMBODIMENT

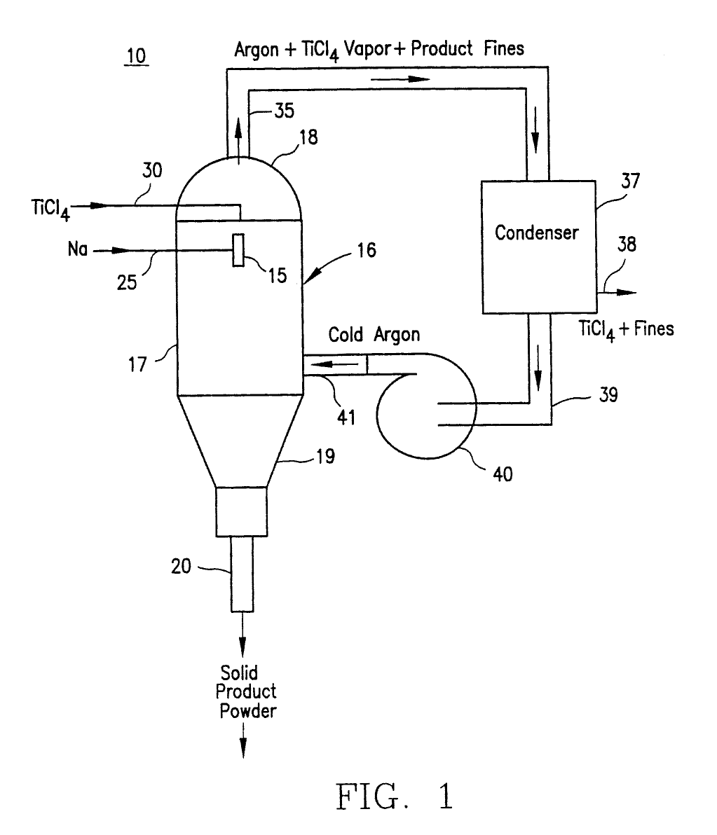

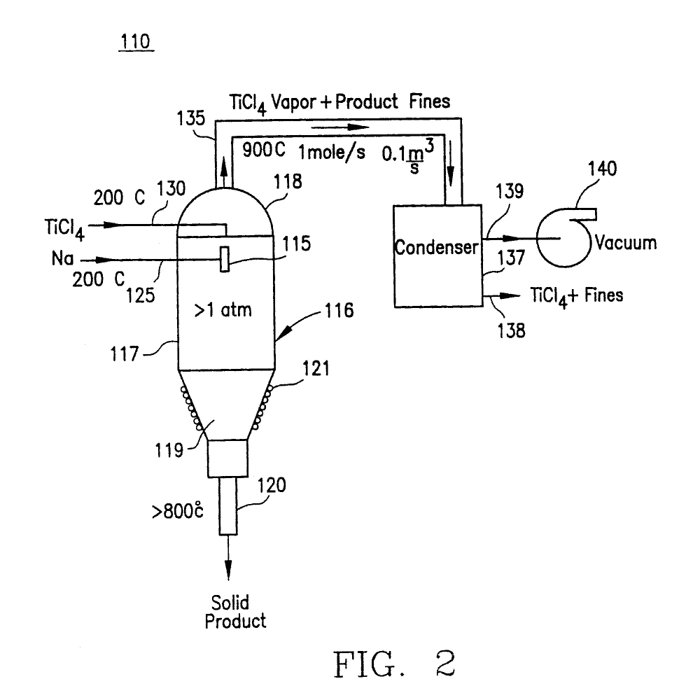

Referring now to FIG. 1 of the drawings, there is disclosed a system 10 for the practice of the invention. The system 10 includes a reactor 15 generally vertically displaced in this example in a drop tower vessel 16, the drop tower 16 having a central generally cylindrical portion 17, a dome top 18 and a frustoconical shaped bottom portion 19. A product outlet 20 is in communication with the frustoconical portion 19. The reactor 15 essentially consists of an apparatus illustrated in FIG. 2 of U.S. Pat. No. 5,958,106, in which a tube through which liquid metal flows as a stream has inserted thereinto a halide(s) vapor so that the vapor halide(s) is introduced into the liquid reducing metal below the surface, preferably through a choke flow nozzle and is entirely surrounded by the liquid metal during the ensuing exothermic reaction; however, it may be that because the amount of halide is either the stoichiometric amount necessary to react with all the reducing metal, or in excess of that amount, some surface reactions may occur. In such case, additional process steps may be required.

A reducing metal inlet pipe 25 enters the reactor 15 near the top 18 and a vapor halide inlet 30 also enters the drop tower 16 near then top 18. However, it will be understood by a person of ordinary skill in the art that a variety of configurations of inlet conduits may be used without departing from the spirit and scope of the present invention.

As illustrated, there is an overhead exit line 35 through which the vapor leaving reactor 15 can be drawn. The overhead exit line 35 leads to a condenser 37 where certain vapors are condensed and discharged through an outlet 38 and other vapor or gas, such as an inert gas, is pumped by a pump 40 through a heat exchanger (not shown) and line 41 into the drop tower 16, as will be explained.

For purposes of illustration, in FIG. 1, there is shown a reducing metal of sodium. It should be understood that sodium is only an example of reducing metals which may be used in the present invention. The present invention may be practiced with an alkali metal or mixtures of alkali metals or an alkaline earth metal or mixtures of alkaline earth metals or mixtures of alkali and alkaline earth metals. The preferred alkali metal is sodium because of its availability and cost. The preferred alkaline earth metal is magnesium for the same reason.

The preferred halide(s) to be used in the process of the present invention is a chloride, again, because of availability and cost. The metals and non-metals which may be produced using the subject invention are set forth in Table 1 hereafter; the alloys of the metals and non-metals of Table 1 are made by introducing mixed halide vapor into the reducing metal.

TABLE

| FEEDSTOCK | HEAT kJ/g |
|---|---|
| TiCl₄ | −5 |
| AlCl₃ | −5 |
| SbCl₃ | −4 |
| BeCl₂ | −6 |
| BCl₃ | −8 |
| TaCl₆ | −4 |
| VCl₄ | −6 |
| NbCl₅ | −5 |
| MoF₅ | −10 |
| GaCl₃ | −5 |
| UF₆ | −4 |
| ReF₆ | −8 |
| ZrCl₄ | −4 |
| SiCl₄ | −11 |

All of the feedstocks (in various combinations) as chlorides or other halides in Table 1 result in an exothermic reaction with an alkali metal or alkaline earth metal to provide the halide(s) of the reducing metal and the metal or alloy of the halides introduced into the reducing metal. Ti is discussed only by way of example and is not meant to limit the invention. Because of the large heat of reaction, there has been the problem that the reaction products fuse into a mass of material which is difficult to process, separate and purify. Discussions of the Kroll and Hunter processes appear in the patents referenced above.

The patents disclosing the Armstrong process show methods and systems of producing a variety of metals and alloys and non-metals in which the heat of reaction resulting from the exothermic reaction is controlled by the use of excess liquid reducing metal. The reaction proceeds instantaneously by introducing the metal halide into a continuous phase of liquid reducing metal, otherwise described as a liquid continuum, at the temperatures illustrated. The use of a subsurface reaction described in the Armstrong process has been an important differentiation between the batch processes and other suggested processes for making metals such as titanium and the processes disclosed in the Armstrong et al. patents.

Nevertheless, the use of excess liquid reducing metal requires that the excess liquid metal be separated before the products can be separated. This is because the excess liquid reducing metal may explosively react with water or is insoluble in water, whereas the particulate products of the produced metal and the produced salt can be separated with water wash.

By way of example, when titanium tetrachloride in vapor form is injected into sodium liquid, an instantaneous reaction occurs in which titanium particles and sodium chloride particles are produced along with the heat of reaction. Excess sodium absorbs sufficient heat that the titanium particles do not sinter to form a solid mass of material. Rather, after the excess sodium is removed, such as by vacuum distillation suggested in the aforementioned Armstrong patents, the remaining particulate mixture of titanium and sodium chloride can be easily separated with water.

Nevertheless, vacuum distillation is expensive and it is preferred to find systems and methods that will permit the separation of the particulate reaction products of the reaction directly with water without the need of preliminary steps. This has been accomplished in the present invention by the discovery that using stoichiometric amounts of reactants or excess halide vapor to absorb some of the heat of reaction, with our without extraneous cooling, significant advantages of the Armstrong process may be retained. For instance, using an excess halide vapor as a heat sink results in particulate products and only vapor phase halide which can be efficiently and inexpensively removed so that the particulates accumulating at the bottom 19 of the reaction vessel or drop tower 16 are entirely free of liquid reducing metal, thereby permitting the separation of the particulate reaction products with water, obviating the need for a separate vacuum distillation step.

In the reactor 15, as previously taught in the Armstrong patents, the continuous liquid phase of sodium (or other reducing metal) is established into which the titanium tetrachloride vapor is introduced and instantaneously causes an exothermic reaction to occur producing large quantities of heat, and particulates of titanium metal and sodium chloride. The boiling point of sodium chloride is 1465° C. and becomes the upper limit of the temperature of the reaction products, whereas the boiling point of titanium tetrachloride is the lower limit of the temperature of the reaction products to ensure that all excess titanium tetrachloride remains in the vapor phase until separation from the particulate reaction products. A choke flow nozzle also known as a critical flow nozzle is well known and is used in the line transmitting halide vapor into the liquid reducing metal, all as previously disclosed in the '761 and '106 patents. It is critical for the present invention that stoichiometric quantities of reactants with extraneous cooling or that excess halide vapor such as TiCl₄ be available with or without extraneous coolants to absorb the heat of reaction to control the temperature of the reaction products.

The vapors exiting the reactor 15 are drawn through exit line 35 along with an inert sweep gas introduced through the inert gas inlet 41. The inert gas, in this example, argon, may be introduced at a temperature of about 200° C., substantially lower than the temperature of the reaction products which exit the tower 16. The argon sweep gas flows, in the example illustrated in FIG. 1, countercurrently to the direction of flow of the particulate reaction products. The excess titanium tetrachloride vapor is swept by the argon into the outlet 35 along with whatever product fines are entrained in the gas stream comprised of argon and titanium tetrachloride vapor at an elevated temperature and transmitted to the condenser 37. In the condenser 37, heat exchange occurs in which the titanium tetrachloride vapor is cooled to about 200° C. and recycled to the titanium tetrachloride feed or inlet 30 via line 38 and the argon is also cooled to about 200° C. temperature at which it is recycled. It is seen therefore, that the inert gas preferably flows in a closed loop and continuously recirculates as long as the process is operational. The product fines present in the condenser 37 will be removed by filters (not shown) in both the titanium tetrachloride recycling line 38 and in the line 39 exiting the condenser 37 with the inert gas.

As the inert gas moves upwardly through the vessel or drop tower 16, there is contact between the colder inert gas and the reaction particulates which are at a higher temperature. Excess titanium tetrachloride vapor exits the drop tower 16 at an elevated temperature while the particulate product exits the reactor 15 at a temperature not greater than 1465° C. After being cooled by contact with the argon gas, the particulate product, in this example, leaves the vessel 16 and enters a cooler (not shown), to exit therefrom at about 50° C. Thereafter, the product may be introduced to a water wash to separate the metal particulates. The titanium particulates exit from the water wash for drying and further processing.

It should be understood that although titanium is shown to be the product in FIG. 1, any of the elements or alloys thereof listed in Table 1 may be produced by the method of the present invention. The most commercially important metals at the present time are titanium and zirconium and their alloys. The most preferred titanium alloy for defense use is 6% aluminum, 4% vanadium, the balance substantially titanium. This alloy known as 6:4 titanium is used in the aircraft industry, aerospace and defense. Zirconium and its alloys are important metals in nuclear reactor technology. Other uses are in chemical processing equipment.

The preferred reducing metals, because of cost and availability, are sodium of the alkali metals and magnesium of the alkaline earth metals. The boiling point of magnesium chloride is 1418° C. Therefore, if magnesium were to be used rather than sodium as the reducing metal, then preferably the product temperature would be maintained below the boiling point of magnesium chloride. The chlorides are preferred because of cost and availability.

One of the significant features of the present invention is the complete separation of the particulate reaction products from any left over reactants as the reaction products leave the reactor 15 thereby providing at the bottom of the drop tower 16 a product which may then be separated with water in an inexpensive and uncomplicated process. If liquid sodium or other reducing metal is trapped within the product particulates, it must be removed prior to washing. Accordingly, the invention as described is an advance with respect to the separation of the metal or alloy particulates after production as disclosed in the aforementioned Armstrong et al. patents and application.

Referring to FIG. 2, there is disclosed another embodiment of the present invention system 110 which includes a reactor 115 disposed within a drop tower 116 having a cylindrical center portion 117, a dome topped portion 118 and a frustoconical bottom portion 119 connected to a product outlet 120. A plurality of cooling coils 121 are positioned around the frustoconical portion 119 of the drop tower 116 for a purpose to be explained.

As in the system 10 shown in FIG. 1, there is a metal halide inlet 130 and a reducing metal inlet 125 in communication with the reactor 115 disposed within the drop tower 116. An overhead exit line 135 leads from the domed top portion 118 of the drop tower 116 to a condenser 137 in fluid communication with a pump 140. An excess vapor and product fine outlet 138 is also provided from the condenser 137. In operation, the system 110 is similar to the system 10 in that a liquid reducing metal, for instance sodium or magnesium, is introduced via inlet 125 from a supply thereof at a temperature above the melting point of the metal, (the melting point of sodium is 97.8° C. and for Mg is 650° C.) such as 200° C. for sodium and 700° C. for Mg. The vapor halide of the metal or alloy to be produced, in this example, titanium tetrachloride, is introduced from the boiler at a temperature of about 200° C. to be injected as previously discussed into a liquid so that the entire reaction occurs instantaneously and is at least initially subsurface. The products coming from the reactor 115 include particulate metal or alloy, and particulate salt of the reducing metal. Also, excess vapor halide of the metal or alloy to be produced may be present. In the system 110, there is no sweep gas, but the drop tower 116 is operated at a pressure slightly in excess of 1 atmosphere and this, in combination with the vacuum pump 140, causes any excess vapor halide leaving the reactor 115 to be removed from the drop tower 116 via the line 135. A certain amount of product fines may also be swept away with the halide vapor during transportation from the drop tower 116 through the condenser 137 and the excess titanium tetrachloride vapor outlet 138. A filter (not shown) can be used to separate any fines from the vapor in line 138.

Cooling coils 121 are provided, as illustrated on the bottom portion 119 of the drop tower 116. A variety of methods may be used to cool the drop tower 116 to reduce the temperature of the product leaving the drop tower 116 through the product outlet 120. As illustrated in FIG. 2, a plurality of cooling coils 121 may be used or alternatively, a variety of other means such as heat exchange fluids in contact with the container or heat exchange medium within the drop tower 116. What is important is that the product be cooled while the excess TiCl₄ remains a vapor so that the vapor phase can be entirely separated from the product prior to the time that the product exits the drop tower 116 through the product outlet 120.

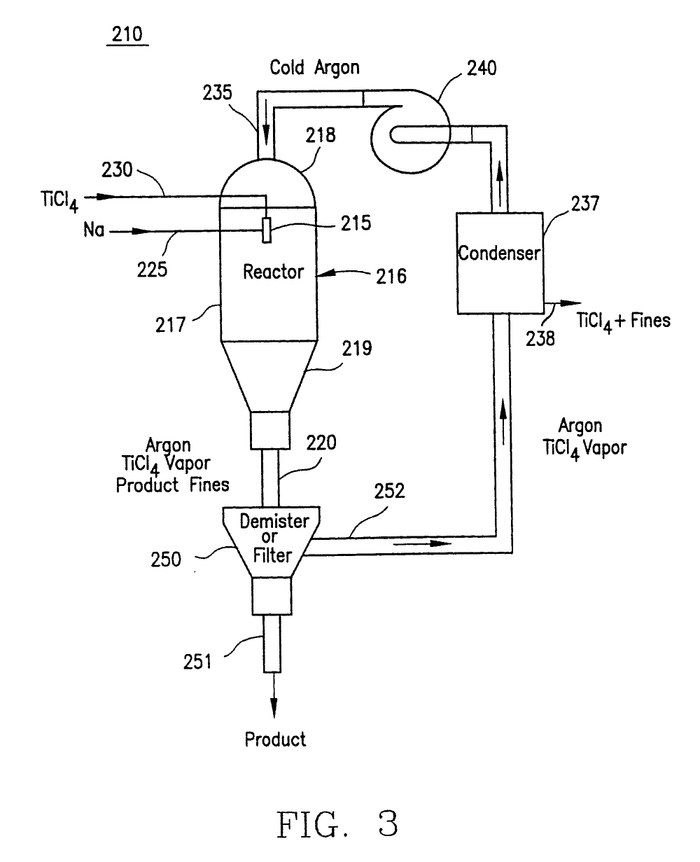

Referring now to FIG. 3, there is disclosed another embodiment of the invention. A system 210 in which like parts are numbered in the 200 series as opposed to the 100 series. Operation of the system 210 is similar to the operation of the system 10, but in the system 210, an inert sweep gas flows co-currently with the product, as opposed to the countercurrent flow as illustrated in system 10 and FIG. 1. In the system 210 illustrated in FIG. 3, the gas flow is reversed in comparison to the system 10. In the system 210, the sweep gas such as argon, the excess (if any) titanium tetrachloride vapor, and the product of titanium particles and sodium chloride exit through the outlet 220 into a demister or filter 250. The demister or filter 250 is in fluid communication with a condenser 237 and a pump 240 so that the excess titanium tetrachloride (if any) vapor and the argon along with whatever fines come through the demister or filter 250 are transported via a conduit 252 to the condenser 237. In the condenser 237, the excess titanium tetrachloride vapor is cooled, the fines are separated while the argon or inert gas is cooled and recycled via the pump 240 in line 235 to the drop tower 216. The inert gas may have to be separated from excess titanium tetrachloride, which can be accomplished by appropriate condensing of the TiCl₄. The other apparatus of the system 210 bear numbers in the 200 series that correspond to the numbers in the system 10 and 100 and represent the same part functioning in the same or similar manner.

It is seen that the present invention can be practiced with a sweep gas that is either countercurrent or co-current with the reaction products of the exothermic reaction between the halide and the reducing metal or without a sweep gas. An important aspect of the invention is the separation of any excess halide vapor prior to the separation of the produced metal and the produced salt. Because excess halide vapor is used as a heat sink or a cooling gas to control the temperatures of the reaction products due to the large heat of reaction, it is possible that conditions may be present which do not occur with the processes taught in the Armstrong et al. '761 or '106 patents. For instance, when titanium tetrachloride is present in excess of the stoichiometric amount needed to react with the reducing metal, certain subchlorides, such as TiCl₃ or TiCl₂, may be formed. Subchlorides are to be avoided, since they may contaminate the produced titanium, requiring further processing. Moreover, it is possible that some of the reaction between the reducing metal, for instance, sodium, and the halide, for instance, titanium tetrachloride, may not be subsurface. This is not preferred because the thermodynamics of a surface reaction are different than a subsurface reaction.

Various alloys can be made using the process of the present invention. For instance, titanium alloys including aluminum and vanadium can be made by introducing predetermined amounts of aluminum chloride and vanadium chloride and titanium chloride to a boiler or manifold and the mixed halides introduced into liquid reducing metal. For instance, grade 5 titanium alloy is 6% aluminum and 4% vanadium. Grade 6 titanium alloy is 5% aluminum and 2.5% tin. Grade 7 titanium is unalloyed titanium and paladium. Grade 9 titanium is titanium alloy containing 3% aluminum and 2.5% vanadium. Other titanium alloys include molybdenum and nickel and all these alloys may be made by the present invention.

Accordingly, there has been disclosed an improved process for making and separating the products of the Armstrong process resulting from the exothermic reaction of a metal halide with a reducing metal. A wide variety of important metals and alloys can be made by the Armstrong process and separated according to this invention.

While there has been disclosed what is considered to be the preferred embodiment of the present invention, it is understood that various changes in the details may be made without departing from the spirit, or sacrificing any of the advantages of the present invention.

What is claimed:

1. A method of producing an elemental material or an alloy thereof from a halide of the elemental material or halide mixtures comprising introducing the vapor halide of an elemental material or halide mixtures thereof into a liquid phase of a reducing metal of an alkali metal or alkaline earth metal or mixtures thereof present in less than or equal to the amount needed to reduce the halide vapor to the elemental material or alloy resulting in an exothermic reaction between the vapor halide and the liquid reducing metal producing particulate elemental material or alloy thereof and particulate halide salt of the reducing metal, cooling the reaction products so that substantially all the particulate elemental material or alloy remains unsintered, and separating the particulate reaction products.

2. The method of claim 1, wherein the elemental material or alloy is one or more of Ti, Al, Sb, Be, B, Ga, Mo, Nb, Ta, V, Zr, U, Re, Si, Os, Ir and mixtures thereof.

3. The method of claim 2, wherein the reducing metal is an alkali metal.

4. The method of claim 3, wherein the reducing metal is Na.

5. The method of claim 4, wherein the elemental material or an alloy thereof includes titanium and the Na is flowing.

6. The method of claim 2, wherein the reducing metal is an alkaline earth metal.

7. The method of claim 6, wherein the reducing metal is Mg.

8. The method of claim 7, wherein the elemental material or alloy thereof includes titanium and the Mg is flowing.

9. The method of claim 2, wherein the alloy is substantially Ti and Al and V and is formed by introducing the chlorides thereof as vapor into a liquid phase of a reducing metal.

10. The method of claim 2, wherein the particulate reaction products are cooled with an inert sweep gas.

11. The method of claim 9, wherein the reducing metal is Na, the inert sweep gas is Ar and the alloy is Ti-6% by weight Al-4% by weight V.

12. The method of claim 9, wherein the reducing metal is Mg, the inert sweep gas is Ar and the alloy is Ti-6% by weight Al-4% by weight V.

13. The method of claim 1, wherein the temperature of the particulate elemental material or alloy thereof is maintained at or below the boiling point of the halide salt of the reducing metal.

14. The method of claim 10, wherein the inert sweep gas flows countercurrently to the particulate reaction products.

15. The method of claim 10, wherein the inert sweep gas flows concurrently with the particulate reaction products; and further including filtering the particulate reaction products from the sweep gas.

16. The method of claim 1, wherein the particulate reaction products move in one direction and are cooled by contact with an inert gas flowing countercurrently to the particulate reaction products, the inert gas separating any excess vapor halide of the elemental material or halide mixtures thereof present from the particulate reaction products before separation of the particulate halide salt of the reducing metal from elemental material or alloy thereof.

17. The method of claim 16, wherein the cooled particulate reaction products are contacted with water to separate the halide salt of the reducing metal from particulate elemental material or alloy thereof.

18. A method of producing a metal element or an alloy thereof in an exothermic reaction between the chloride of the metal element or the chlorides of the constituents of the alloy and a reducing metal of an alkali metal or an alkali earth metal or mixtures thereof, comprising establishing a liquid phase of the reducing metal and introducing the vapor chloride or vapor chlorides of the metal or alloy to be produced into the liquid phase of the reducing metal in an amount equal to or less than the stoichiometric amount needed to react with the reducing metal to produce particulate reaction products of the metal element or alloy thereof and particulate chloride salt of the reducing metal and heat, cooling the reaction products to prevent sintering of the particulate metal element or alloy, and separating the cooled particulate metal element or alloy from the chloride salt of the reducing metal.

19. The method of claim 18, wherein the particulate reaction products are cooled by contact with flowing gas cooler than the reaction products.

20. The method of claim 19, wherein the flowing gas is inert with respect to the particulate reaction products and flows through the particulate products to cool the particulate reaction products and to separate any chloride vapor from the particulate reaction products.

21. The method of claim 20, wherein the metal element is Ti or alloys thereof or Zr or alloys thereof and the reducing metal is Na or an alkaline earth metal.

22. The method of claim 21, wherein the alkaline earth metal is Mg.

23. The method of claim 21, wherein the metal element is Ti.

24. The method of claim 21, wherein the alloy includes Ti and V and Al.

25. The method of claim 18, wherein any excess halide vapor present is separated from the reaction products.

26. A product made by the method of claim 1.

27. A product made by the method of claim 18.
